(19) United States
(12) Patent Application Publication
(10) Pub. No.: US 2003/0216944 A1
(43) Pub. Date: Nov. 20, 2003

(54) Communication system, especially for medical applications

(76) Inventor: Robert Stavis, Bryn Mawr, PA (US)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/147,028

(22) Filed: May 16, 2002

(51) Int. Cl. G06F 17/60

(52) U.S. Cl. 705/3

(57) ABSTRACT

e-mail letters are transmitted to parents or other interested parties in the case of a neonate in a hospital to inform the interested party of the current status based upon data and medical information in the patient's records, utilizing sets of statements which are selected randomly so that each letter differs from previous and succeeding letters and is personalized by the random selection. The method has general business applications as well.

### FIELD OF THE INVENTION

My present invention relates to a communication system, especially an e-mail communication system suitable for a variety of businesses and particularly germane to informing interested parties of medical conditions, i.e. is especially appropriate for medical communication.

### BACKGROUND OF THE INVENTION

Communication systems which utilize the automatic translation of a communication, for example, an e-mail, are widely used throughout the business community. In certain businesses as in the medical field, there is a need for a more personalized communication system which is keyed to data which can be or has been collected and can inform an individual or receiver, hereinafter identified as an interested recipient or party, of a condition, status, event or combination thereof relevant to a specific subject, patient or occurrence.

For example, in medical institutions working with neonates, for example, hospitals, clinics and medical offices, documentation systems have been developed which can collect a significant amount of data with respect to a patient and at least some of which may be current and should be advised to the patient or an interest party like the parent.

For example, MacNICU is a computerized nursing and physician documentation system for a neonatal intensive care unit. The system emulates conventional charting on paper flow sheets, and nurses and Respiratory Therapists enter variables into the system regarding a baby's weight, heart rate, respiratory rate, blood pressure, oxygen levels, amounts of milk taken, intravenous fluids given, urine and stood outputs, respiratory support data, laboratory information, and data on many other parameters that reflect the baby's condition, care and interventions. Physicians also enter admission notes, physical exams, and daily progress notes into the system. The system essentially contains the medical record for infants in the Neonatal Intensive Care Unit.

That system, of course, is only representative of many documentation systems which are available to collect data relevant to a particular patent and documentation systems which are available in other businesses to collect data relevant to a particular subject.

In the case of hospital patients and particularly patients in neonatal care units, it is important to communicate with the patient, where the patient is capable of understanding the communication, or with an interested party such as the parent or guardian of a patient, not only in the case of an emergency situation but also periodically and in fact on a day to day basis so that that parent or guardian is fully apprised not only of data which may be relevant to the status of the patient, but also analytical information which can indicate the status of the patient, the patient's wellbeing and comfort, and any other information which can be beneficial to the interested parties. In addition, the daily communications should also include whatever instructions may be relevant to the care and wellbeing of the patient, even if those instructions are in principle ongoing.

Similarly in other businesses, a daily communication or communications with a like frequency may be desirable for similar informative purposes.

Currently it is the practice of most institutions and businesses issuing daily communications as to status or documenting the change in status resulting from tests or events which are stored in the documentation data base, to generate a form which is highly repetitive and which differs form the previous days's communication only in numerical values which may have changed since the previous form issued. The result is that the communication is cold and lacks sympathy in the case of medical practices and especially the neonatal field in which the separation of the neonate from the parent itself is extremely traumatic. In many business the cold use of repetitive forms leads to disregard of the communication.

Furthermore, the communication of raw data and the consequences thereof is frequently very time-consuming and complex.

### OBJECTS OF THE INVENTION

It is therefore the principal object of the present invention to provide an improved communication system for the purposes mentioned at the outset which will be free from these drawbacks and, especially, will be time-saving and capable of conveying raw data more effectively.

More particularly, it is an object of this invention to provide a communication system which will sympathetically and effectively daily inform an interested party of the condition of a neonate without the coldness implied by forms which represent numerical values only and which also will convey a caring and individualized approach to the case.

In more general terms it is an object of the method to provide a communication system which is more personalized than the communication systems which have been used heretofore to convey information, in spite of the fact that the information may derive from newly obtained data stored in a documentation system.

It is an additional object of this invention to more efficiently communicate with the parent or guardian of a patient where multiple communications are necessary.

### SUMMARY OF THE INVENTION

I have found that the effect of communication between an institution and an individual and particularly with an individual responsible for a patient in that institution such as a neonate, can be greatly improved by personalizing the communications in spite of the fact that it may have data which may be numerical in nature and itself can be considered cold and incapable of presentation in a sympathetic manner. This can be achieved by providing a series of communications, namely daily communications, which unlike standard documentary communications from most institutions, are nonrepetitive and include information in a letter which also contains phrases, expressions and material which can differ from letter to letter in spite of the fact that numerical and like information is conveyed as part of the communication.

Preferably the communication is by e-mail, transferring a message to an internet web site, telefax or by other electronic or nonelectronic means. In all cases, according to the invention, the communication is computer generated.

In the case where the subject is a patient, the method of the invention is a method of communicating medical status which comprises the steps of:

(a) storing in a database respective pluralities of phrases each representing a particular medical condition for a multiplicity of medical conditions of each of a number of patient classes;

(b) registering for particular patients data representing a respective patient class and sufficient to enable a particular medical condition for the respective patient to be calculated;

(c) automatically calculating from the data registered for each patient the particular medical condition of that patient over a period of treatment;

(d) at time-spaced intervals during the treatment of each of the patients, based upon the particular medical condition at the respective point in time, randomly selecting a respective phrase from the plurality of phrases assigned to the particular medical condition for the patient of the respective class; and

(e) transmitting the randomly selected phrase to a party interested in the well-being of the respective patient by an electronic communication medium.

As will be noted below in greater detail, the selection of the phrase or expression is preferably random and based upon a random number generated in the computer. Other nonrepetitive selection methods may be used, for example, selection of a phrase based upon some calendar characteristics, timing characteristics or the like.

According to a feature of the invention the randomly selected phrase is transmitted to the party interested in the well-being of the respective patient by an electronic communication medium.

Alternatively the randomly selected phrase is transmitted to the party interested in the well-being of the respective patient by mail. The party interested in the wellbeing of the patient is usually a parent or guardian of the patient as in the case of a neonate, although the party receiving the communication can be a patient his or herself.

### BRIEF DESCRIPTION OF THE DRAWING

The above and other objects, features, and advantages will become more readily apparent from the following description, reference being made to the accompanying drawing in which:

FIG. 1 is a block diagram of a system for producing communications in accordance with the invention; and

FIG. 2 is an e-mail screen for use with that system.

### SPECIFIC DESCRIPTION

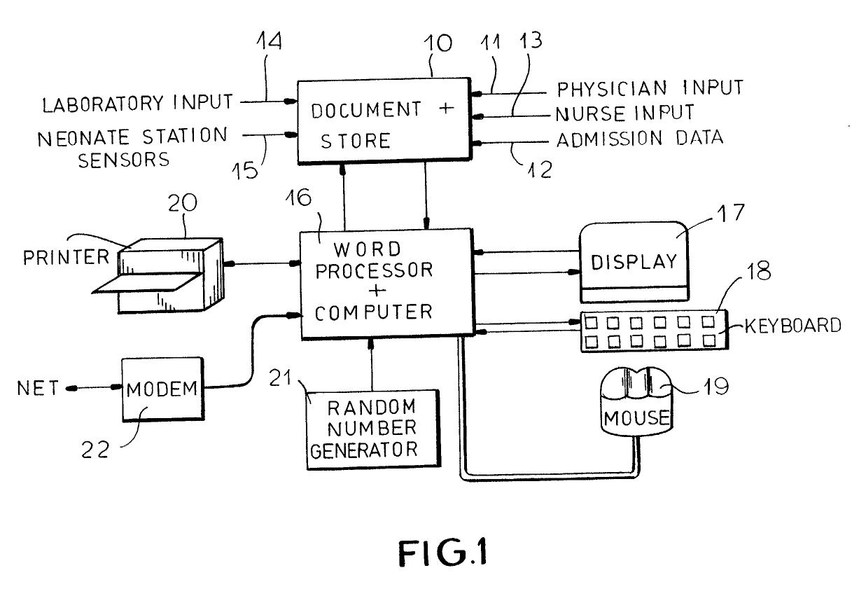

The system shown in FIG. 1 comprises a computer which may be incorporated or can include the computerized sensing and conventional documentation system for a Neonatal Intensive Care Unit and which is a module 10 for the documenting and storing the various inputs and data. For example, the module 10 can have physician inputs at 11 whereby the physician can enter information with respect to admission notes made by the physician, physical examinations and daily progress notes. Admission data can also be entered at 12 by the admissions office and nurse inputs can be provided at 13 which can represent the inputs form respiratory therapists and attending nurses as to the baby's weight, heart rate, respiratory rate, blood pressure, oxygen level, amounts of food or milk taken, intravenous input, urine and stool outputs, respiratory data and other laboratory information and information as to the daily or other periodic reviews of condition, care and intervention. The input 14 represents laboratory result inputs and input 15 represents input from the neonatal station which can be converted directly into storable and usable data.

The computer has the usual word processing module 16 which can be coupled with a display 17, a keyboard 18, and a mouse 19 as well as other input peripherals as may be required. A printer 20 can be likewise hooked up to the computer to enable charting of the data on conventional flow sheets and printout of the communications which are transmitted. A random number generator 21 is likewise connected to the computer as is a modem 22 permitting the e-mail which is developed to be transmitted onto the net.

The e-mail system was developed to automatically summarize certain data that would be of interest to parents, and to format the data as an easily understood e-mail from the baby to his/her parents. The baby's nurse reviews the data and may add or edit information. The nurse then clicks a button which triggers the sending of the e-mail and copies the text into the nursing notes for preservation in the medical record.

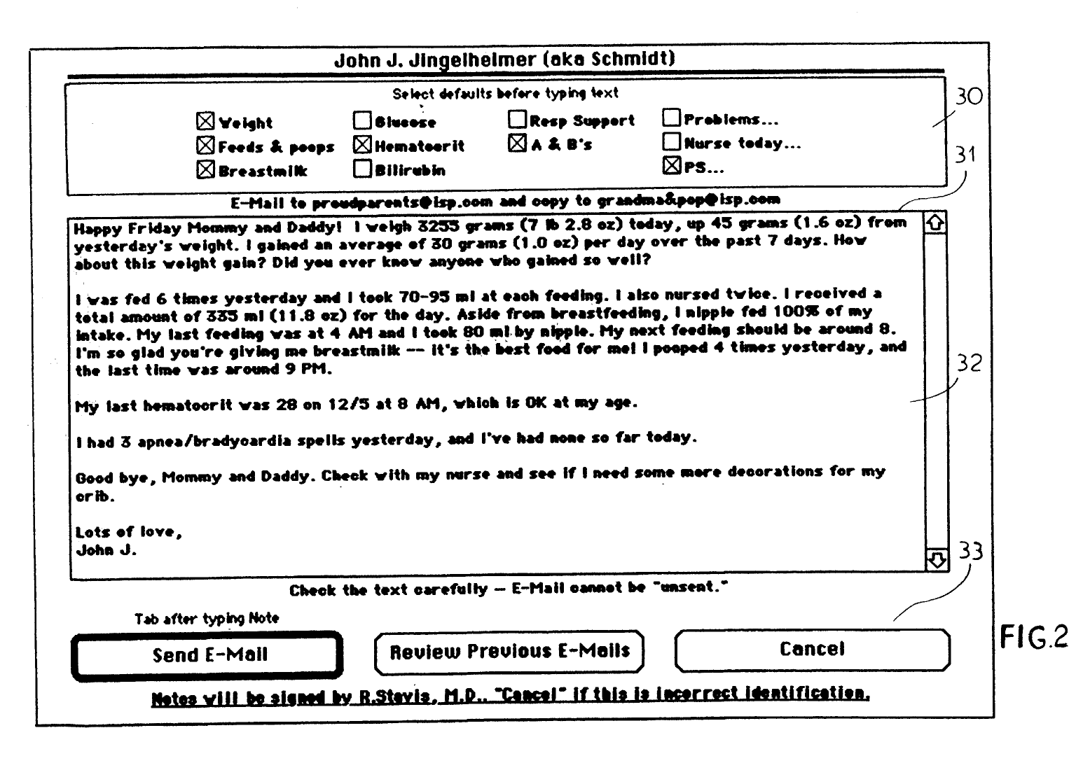

FIG. 2 shows a screen displaying a typical e-mail which may be generated based upon the data stored at 10. The field 30 to be checked by the nurse shows the data which is considered important to convey. Field 31 represents the e-mail address of the interested party or parties, field 32 contains the text and field 33 the buttons for sending the e-mail, reviewing previous e-mail or canceling the e-mail being generated. A key is the storage of the statements which are randomly selected.

A unique feature of the e-mail system is the use of variable data-dependent interpretative comments. For example, based on the daily weights that are measured and entered into the system, MacNICU calculates an average daily weight gain. For babies who gain an average of over 30 grams/day over 7 days (which is an excellent weight gain),the e-mail includes one of a series of statements such as:

This is a fine weight gain. I'm on the right track.

Look at me! I'm growing right in front of your eyes!

Aren't you proud of the way I'm gaining weight!

I'm getting bigger and bigger day by day. Pretty soon I'll need some new clothes. Be sure to get me some good looking stuff!

For babies who have not gained weight over 7 days, an issue of some clinical concern, the e-mail would include one of a series of statements such as:

Keep thinking positive thoughts. I'll be gaining weight soon.

Gaining weight is sure hard work. Just think—everyone thinks its the easiest thing in the world! Well, I will get going on this weight-gain thing soon.

I'm sure I'll get this gaining-weight thing squared away soon.

I'm sure I'll start gaining weight soon—it just isn't happening yet.

I haven't been gaining much weight yet, but before you know it, I'll be begging for cookies.

Sentences/phrases are stored in tables. The table that is used is defined by the calculated data result, and the sentence/phrase within the table is randomly picked for inclusion in the e-mail. Similar types of sentences/phrases are used for a number of other calculated variables in the e-mails. The system also includes random variation in nondata driven sentences/phrases. For example, e-mails end with such sentences as:

Check with my nurse and see if I need some more decorations for my crib.

Are you sure I have enough toys?

I think I need some pictures around me, so please bring me some.

I'd like something very cuddly, please. Thank you muchly.

Please come and see me soon.

I need some kisses, so visit me soon.

I want to tell you all about what's happening here, so come visit me soon.

I love when you come. Your visits calm me down and help me sleep better.

The current computerized process uses a random number generator to pick a sentence/phrase, but the business process concept includes all methods of selecting a sentence/phrase such as (but not limited to) sequential use or random assignment with rules to preclude the use of a sentence/phrase twice in a row.

The use of data-driven statements/phrases is widely used in computerized communication systems and is not unique to the e-mail system described above. The unique feature of this system is the variation in the data-driven and nondata driven statements. The ability to vary statements/phrases has broad applicability in any communication system in which variation is desirable, and would be particularly useful for systems generating repetitive frequent messages to a recipient. This business process has obvious utility in the communication process of any health care or long-term care facility in which frequent information is sent to family members regarding a patient/resident. The business process might also be useful in marketing or other applications in which variation of the message could be used to produce a seemingly personal message.

I claim:

1. A method of communicating medical status, comprising the steps of:
(a) storing in a database respective pluralities of phrases each representing a particular medical condition for a multiplicity of medical conditions of each of a number of patient classes;
registering for particular patients data representing a respective patient class and sufficient to enable a particular medical condition for the respective patient to be calculated;
(c) automatically calculating from the data registered for each patient the particular medical condition of that patient over a period of treatment;
(d) at time-spaced intervals during the treatment of each of said patients, based upon the particular medical condition at the respective point in time, randomly selecting a respective phrase from the plurality of phrases assigned to the particular medical condition for the patient of the respective class; and
(e) transmitting the randomly selected phrase to a party interested in the well-being of the respective patient by an electronic communication medium.

2. The method defined in claim 1 wherein the randomly selected phrase is transmitted to said party interested in the well-being of the respective patient by an electronic communication medium.

3. The method defined in claim 1 wherein the randomly selected phrase is transmitted to said party interested in the well-being of the respective patient by mail.

4. The method defined in claim 1 wherein said party interested in the well-being of the respective patient is a parent of the patient.

5. The method defined in claim 1 wherein said party interested in the well-being of the respective patient is the patient.

6. The method defined in claim 1 wherein the patient is a neonate.

7. A method of communication which comprises the steps of:
collecting data and information as to a matter requiring periodic reports to at least one interested party;
storing tables of previously developed different statements with each table representing a certain status of the matter measured by at least some of the collected data and information;
periodically generating electronically respective communications to said party at least in part by automatically selecting a respective table of statements based upon the collected data and information for a corresponding period and then selecting, based upon a nonrepetetive rule, a specific statement from the selected table and incorporating the specific statement in the communication for the corresponding period along with collected data; and
electronically transmitting the communication to the party.

8. The method defined in claim 7 wherein the nonrepetetive rule is a random selection.

9. The method defined in claim 8 wherein said collected data and information are stored.

10. The method defined in claim 9 wherein said communication is transmitted electronically as e-mail.

11. The method defined in claim 10 wherein said matter is a medical matter involving a patient and said party is the patient or a relative or guardian of the patient.

12. The method defined in claim 11 wherein said patient is a neonate.
